(19) United States
(12) Patent Application Publication
(10) Pub. No.: US 2012/0059866 A1
(43) Pub. Date: Mar. 8, 2012

(54) METHOD AND APPARATUS FOR PERFORMING FLOATING-POINT DIVISION

(75) Inventors: James Conyngham, Austin, TX (US); Jeffrey T. Brady, Orlando, FL (US); Christopher L. Spencer, Oviedo, FL (US)

(73) Assignee: ADVANCED MICRO DEVICES, INC., Sunnyvale, CA (US)

(21) Appl. No.: 12/875,757

(22) Filed: Sep. 3, 2010

(51) Int. Cl. G06F 7/44; G06F 7/42

(52) U.S. Cl. 708/503; 708/504; 708/505

(57) ABSTRACT

A method and apparatus provides for performing floating-point division using input check/output correction floating-point division logic and a floating-point division fix-up instruction (e.g., an instruction, command, signal or other indicator). In one example, the apparatus includes a processor having a floating-point arithmetic logic unit (ALU) that includes the input check/output correction floating-point division logic. The input check/output correction floating-point division logic is responsive to the floating-point division fix-up instruction executable by the floating-point ALU that causes the input check/output correction floating-point division logic to examine a first input representing a numerator and a second input representing a denominator to determine whether a special case of floating-point division occurs. The floating-point division fix-up instruction also causes the input check/output correction floating-point division logic to provide an output representing a floating-point division result based on the determined special case of floating-point division and a third input representing a candidate quotient.

### BACKGROUND OF THE DISCLOSURE

The disclosure relates generally to a method and apparatus for performing floating-point division.

Division of floating-point numbers has been addressed in various ways in different computer architectures for applications such as computer graphics and non-graphical computer processing and calculations. For example, floating-point division is used for computing matrix inverse in three-dimensional (3D) graphic modeling and rendering to generate 3D graphic objects for output to display screens, or used by an averaging (mean) filter for smoothing image data and eliminating noise. Floating-point division is also used in numeric algorithms such as the computation of eigenvectors and eigenvalues, the interpolation of linear functions or polynomials, and the computation of transcendental functions, rational functions, and partial differential equations.

Many instruction set architectures (ISAs) define computer instruction(s) for performing floating-point division operation. As a part of the Institute of Electrical and Electronics Engineers (IEEE) Standard for Floating-Point Arithmetic (IEEE 754, hereinafter “IEEE Std. 754”), floating-point division operation is defined in a number of aspects. For ISAs that are compliant with IEEE Std. 754, in addition to numerically calculating the quotient, special cases of floating-point division, such as an infinite or indeterminate value of the numerator, and an infinite, indeterminate or zero value of the denominator, have to be identified and properly handled, which may require substantial logic operations.

These instructions for floating-point division may be fully implemented using logic circuits and microcode. FIG. 1 shows an example of performing floating-point division operation in a central processing unit (CPU) 100. The CPU 100 includes a floating-point arithmetic logic unit (ALU) 102 having a dedicated floating-point divider 104. The floating-point ALU 102 can execute a DIVPD (packed double-precision floating-point divide) instruction 106 stored in memory 108, which can cause the floating-point divider 104 to perform the floating-point division operation upon execution by the CPU 100. The numerator and denominator of the floating-point division operation may be read from registers 110, and the result may be written to the registers 110. In particular, the functions of numerical calculation of the quotient and special case check and correction are all implemented by the floating-point divider 104 with the DIVPD instruction 106. Due to the complex nature of floating-point division compared with other floating-point operations, the floating-point divider 104 consists of a large number of transistors, thereby increasing the cost and die area of the CPU 100. Especially, as the number of the floating-point dividers 104 depends on the number of “cores” in the CPU 100, such problem is further exacerbated when attempting to apply the same floating-point divider 104 and instruction 106 to graphic processing unit (GPU) or general-purpose computing on GPU (GPGPU) designs due to the fact that GPUs or GPGPUs normally have a larger number of “cores” for parallel stream processing compared with CPUs.

On the other hand, some computer architectures, recognizing the problem of fully implementing floating-point division operation using dedicated logic circuits and instructions, completely omit dedicated floating-point division instructions. Instead, these computer architectures implement floating-point division operation using known iterative algorithms such as Newton-Raphson method without having a dedicated floating-point division instruction and a floating-point divider. For example, FIG. 2 shows an example of implementing floating-point division operation in a GPU 200 using instructions stored in memory 202 including at least a floating-point addition/subtraction instruction 204 and a floating-point multiplication instruction 206, along with one or more floating-point adder/subtractor 208 and floating-point multiplier 210 in one or more floating-point ALUs 212 without dedicated floating-point dividers. In this example, the quotient of floating-point division is numerically calculated in terms of successive approximations using floating-point addition/subtraction and multiplication operations that converge quickly. Compared with the dedicated floating-point divider 104 and instruction 106 shown in FIG. 1, the design of floating-point adder/subtractor 208 and floating-point multiplier 210 in FIG. 2 is less complex. Thus, these computer architectures are more cost-effective in terms of floating-point division operation. However, the iterative algorithms only numerically calculate the quotient of the floating-point division. As described above, to comply with IEEE Std. 754, additional instructions such as conditional instructions (e.g., conditional move, conditional branch, and conditional trap) and logic instructions 214 are required to identify and handle the special cases of floating-point division. In this case, the execution time of floating-point division operation is thus considerably increased by adding the feature of special case check and correction. For example, the floating-point division operation in FIG. 2 may require up to 30 extra conditional and logic instructions 214 that take up to 30 clock cycles for execution. Accordingly, although the design complexity and cost are reduced in FIG. 2, the execution time of floating-point division operation is increased in order to comply with the requirement of special cases handling in IEEE Std. 754.

Moreover, in addition to providing the floating-point division result, IEEE Std. 754 also defines exceptions (e.g., invalid operation, division by zero, etc.) that shall be signaled when they arise. The signal invokes default or alternate handling for the signaled exception, such as enabling processing of a trap sequence, which interrupts the normal flow of instruction execution. For each kind of exception, the implementation shall provide a corresponding status flag. Some computer architectures although having the feature of special case check and correction, lack of the exception status flag and thus, do not fully comply with IEEE Std. 754.

Accordingly, there exists a need for improved method and apparatus for performing floating-point division.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of implementing floating-point division operation in a central processing unit;

FIG. 2 is a block diagram illustrating one example of implementing floating-point division operation in a graphic processing unit;

FIG. 3 is a block diagram illustrating one example of an apparatus including input check/output correction floating-point division logic in accordance with one embodiment set forth in the disclosure;

FIG. 4 a block diagram illustrating one example of the input check/output correction floating-point division logic shown in FIG. 3;

FIG. 5 is an exemplary instruction format of a floating-point division fix-up instruction shown in FIG. 3;

FIG. 6 is another exemplary instruction format of a floating-point division fix-up instruction shown in FIG. 3;

FIG. 7 is an exemplary format of an arbitrary bit pattern shown in FIG. 3;

FIG. 8 is a flowchart illustrating one example of a method for performing floating-point division in accordance with one embodiment set forth in the disclosure;

FIG. 9 is a flowchart illustrating another example of a method for performing floating-point division; and

FIG. 10 is a flowchart illustrating still another example of a method for performing floating-point division.

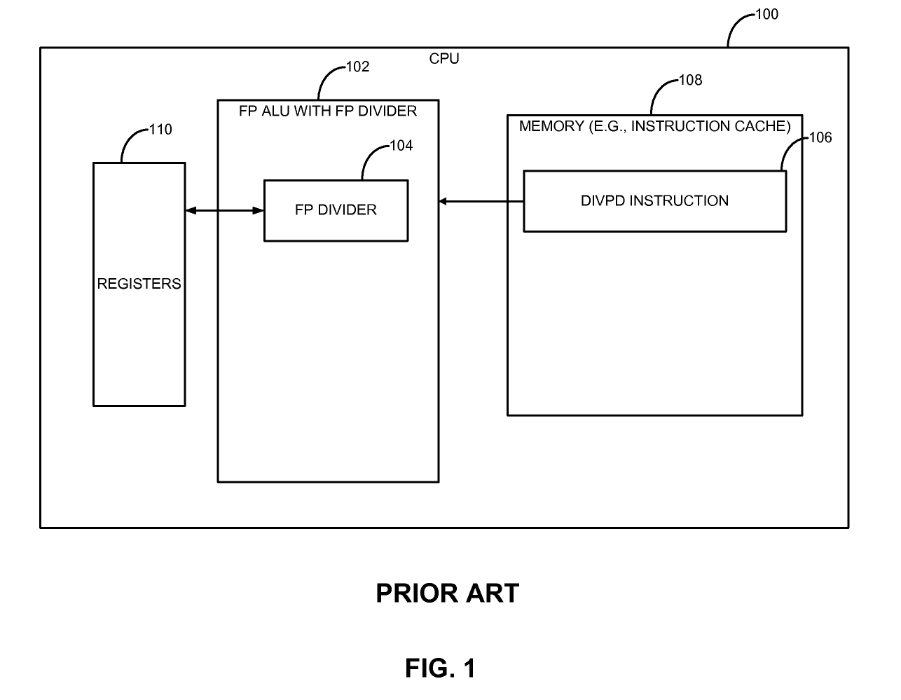

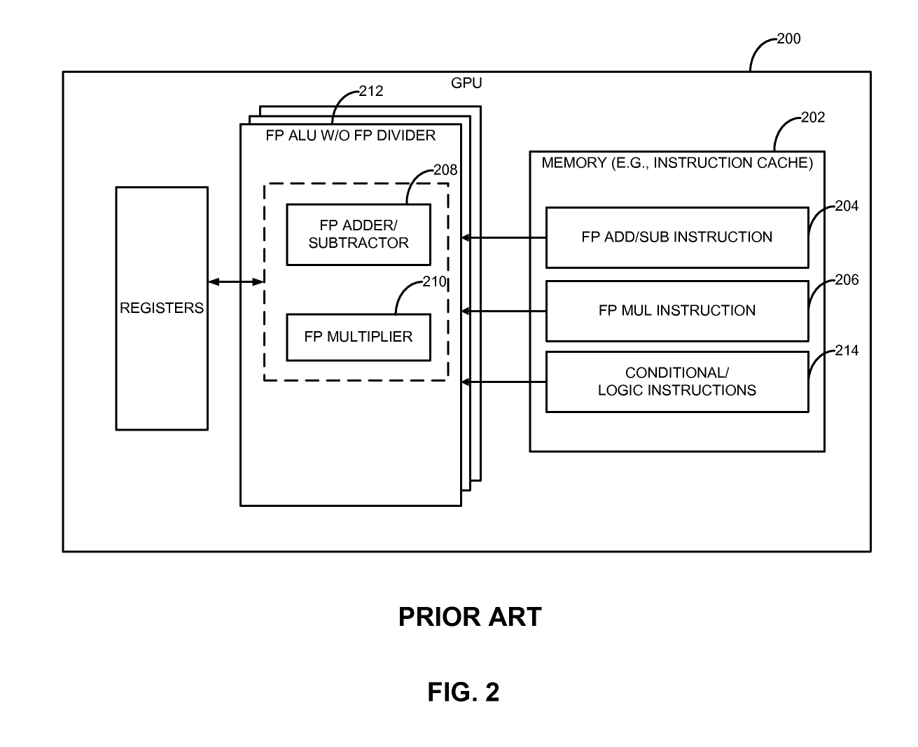

### DETAILED DESCRIPTION OF THE PREFERRED EMBODIMENTS

Briefly, in one example, a method and apparatus performs floating-point division using a floating-point division fix-up instruction (e.g., an instruction, command, signal or other indicator) that causes input check/output correction floating-point division logic to examine a first input representing a numerator and a second input representing a denominator to determine whether a special case of floating-point division occurs. In addition, it provides an output representing a floating-point division result based on the determined special case of floating-point division and a third input representing a candidate quotient. The floating-point division fix-up instruction may be, for example, a single instruction that is executed in one clock cycle, or comprised of an input check instruction and an output correction instruction, wherein each instruction is executed in one clock cycle. The input check/output correction floating-point division logic may be, for example, part of a graphic processing unit.

Among other advantages, for example, the method and apparatus for performing floating-point division provides the ability to enable implementation of floating-point division to be shorter and faster while still being IEEE Std. 754 compliant. The numerical portion of the floating-point division is still calculated by iterative algorithms using the existing floating-point adder/subtractor and multiplier with the corresponding instructions, thereby making the method and apparatus cost-efficient. On the other hand, by applying input check/output correction floating-point division logic and a corresponding floating-point division fix-up instruction, the multiple time-consuming conditional and logic instructions (up to 30 instructions) for recognizing and handling special cases of floating-point division can be replaced in order to reduce the execution time.

In one example, the apparatus includes a processor having a floating-point arithmetic logic unit that includes the input check/output correction floating-point division logic. The input check/output correction floating-point division logic is responsive to the floating-point division fix-up instruction executable by the floating-point arithmetic logic unit that causes the input check/output correction floating-point division logic to examine a first input representing a numerator and a second input representing a denominator to determine whether a special case of floating-point division occurs. The floating-point division fix-up instruction also causes the input check/output correction floating-point division logic to provide an output representing the floating-point division result based on the determined special case of floating-point division and a third input representing a candidate quotient.

The input check/output correction floating-point division logic may include a plurality of special case test circuits operative to examine the first input representing the numerator and the second input representing the denominator to determine whether the special case of floating-point division occurs. The plurality of special case test circuits may include a not-a-number test circuit operative to determine whether the numerator or the denominator is not-a-number, a zero test circuit operative to determine whether the numerator or the denominator is zero, and an infinity test circuit operative to determine whether the numerator or the denominator is infinity. The plurality of special case test circuits may also include an overflow/underflow test circuit operative to determine whether an overflow or an underflow occurs based on the numerator and the denominator.

The input check/output correction floating-point division logic may also include a priority multiplexer operative to provide the output representing the floating-point division result based on the determined special case of floating-point division and the third input representing the candidate quotient. The processor may include a plurality of registers operative to store the numerator, the denominator, the candidate quotient, and the floating-point division result.

The floating-point arithmetic logic unit may also include at least one floating-point adder/subtractor and at least one floating-point multiplier. The at least one floating-point adder/subtractor and floating-point multiplier are responsive to a plurality of instructions executable by the floating-point arithmetic logic unit that causes the at least one floating-point adder/subtractor and floating-point multiplier to numerically calculate the candidate quotient based on the numerator and the denominator without regard to the special case of floating-point division.

The input check/output correction floating-point division logic may be further responsive to the floating-point division fix-up instruction executable by the floating-point arithmetic logic unit that causes the input check/output correction floating-point division logic to, if the special case of floating-point division does not occur, provide the candidate quotient as the output representing the floating-point division result.

The input check/output correction floating-point division logic may be also responsive to the floating-point division fix-up instruction executable by the floating-point arithmetic logic unit that causes the input check/output correction floating-point division logic to, if the special case of floating-point division occurs, provide a corresponding special value of floating-point division as the output representing the floating-point division result. The special value of floating-point division may be selected from at least one of not-a-number, zero, infinity, maximum float constant, and minimum float constant.

In one example, the input check/output correction floating-point division logic includes sign bit setting logic, operatively connected to the priority multiplexer, operative to set a sign bit of the output representing the floating-point division result based on a sign bit of the first input representing the numerator and a sign bit of the second input representing the denominator.

In another example, the output representing the floating-point division result is a first output of the input check/output correction floating-point division logic. The input check/output correction floating-point division logic also includes exception flag logic operative to determine an exception status flag based on the first input representing the numerator and the second input representing the denominator. The exception flag logic is further operative to provide a second output representing the exception status flag of the input check/output correction floating-point division logic.

In still another example, the input check/output correction floating-point division logic includes an arbitrary bit pattern encoder operative to encode an arbitrary bit pattern indicating whether the special case of floating-point division occurs. The arbitrary bit pattern encoder is further operative to store the arbitrary bit pattern into one of the plurality of registers.

Among other advantages, the method and apparatus for performing floating-point division provides the ability to enable implementation of floating-point division to be shorter and faster while still being IEEE Std. 754 compliant. The numerical portion of the floating-point division is still calculated by iterative algorithms using the existing floating-point adder/subtractor and multiplier with the corresponding instructions, thereby making the method and apparatus cost-efficient. On the other hand, by applying input check/output correction floating-point division logic and a corresponding floating-point division fix-up instruction, the multiple time-consuming conditional and logic instructions (up to 30 instructions) for recognizing and handling special cases of floating-point division can be replaced in order to reduce the execution time. The proposed techniques, therefore, may be suitable for parallel stream processors such as Single Instruction Multiple Data (SIMD) processors like graphic processing units (GPUs) and/or general-purpose computation on GPUs (GPGPU) used in computer graphics and/or non-graphic processing and computations. Moreover, the method and apparatus for performing floating-point division can be compliant with IEEE Std. 754. Accordingly, the proposed techniques can retain the benefits of lower processor design and manufacturing costs and the benefit of flexibility of iterative algorithm implementation, while with a low instruction count and a fast execution speed. Other advantages will be recognized by those of ordinary skill in the art.

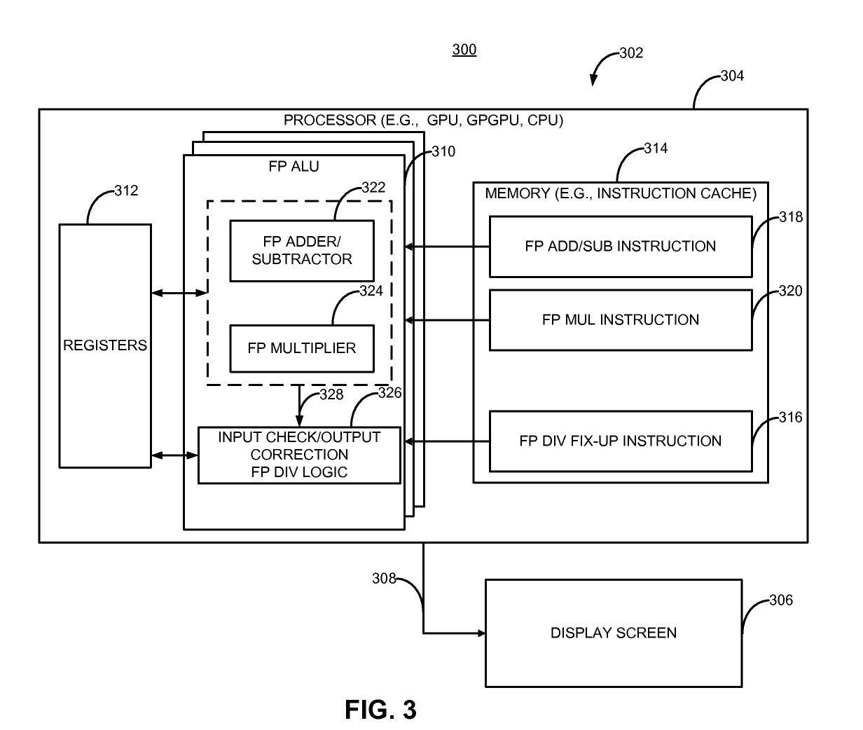

FIG. 3 illustrates one example of an apparatus 300 including an integrated circuit 302 that includes a processor 304. The apparatus 300 may be but is not limited to, for example, a laptop computer, desktop computer, media center, handheld device (e.g., mobile or smart phone, tablet, etc.), Blu-ray™ player, gaming console, set top box, printer or any other suitable device. The integrated circuit 302 may be any suitable circuit that has one or more processors 304. In addition to the processor 304, the integrated circuit 302 may also include any other suitable circuit known in the art such as cache memory and input/output (I/O) interface circuits, to name a few. The processor 304 may be but is not limited to a GPU, a central processing unit (CPU), a GPGPU or an accelerated processing unit (APU), a digital signal processor (DSP) or any other suitable processor. The apparatus 300 may include or operatively couple to one or more display screens 306. The processor 304 may be, for example, a GPU for generating image data 308 that represents at least a portion of an image displayed on the display screens 306.

The processor 304 may include a floating-point ALU 310, registers 312, and memory 314. The registers 312 may be processor register or general purpose registers on the processor 304 whose contents can be accessed more quickly than storage available elsewhere. Preferably, the registers 312 in this example include floating-point registers storing floating-point numbers such as floating-point numerators, denominators, and quotients. The registers 312 may also include instruction registers that store instructions currently being executed, and control and status registers for storing the exception status flag required by IEEE Std. 754. The data stored in the registers 312 may be read or written by the floating-point ALU 310. The memory 314 may be any suitable memory known in the art that permanently or temporality stores a plurality of instructions 316-320 (e.g., an instruction, command, signal or other indicator) executable by the floating-point ALU 310. In this example, the memory 314 is an instruction cache or instruction buffer of the processor 304 to speed up executable instruction fetch. The memory 314 may also be a main memory operatively connected to the processor 304 in other examples. The instructions 316-320 include a floating-point division fix-up instruction 316, floating-point addition/subtraction instruction 318, and floating-point multiplication instruction 320, and any other suitable instruction if desired.

The floating-point ALU 310, in this example, is an ALU dedicated to perform floating-point operations. As shown in FIG. 3, the processor 304 may include more than one floating-point ALUs 310 that perform parallel floating-point operations for stream processing. The floating-point ALU 310 can receive and execute instructions and perform the floating-point operations according to the execution of the instructions. The floating-point ALU 310 may include at least one floating-point adder/subtractor 322 and at least one floating-point multiplier 324 that can numerically calculate the quotient of floating-point division in response to a plurality of instructions including the floating-point addition/subtraction and multiplication instructions 318, 320. As noted above, the floating-point adder/subtractor and multiplier 322, 324 do not recognize and handle the special cases of floating-point division; and the floating-point addition/subtraction and multiplication instructions 318, 320 assume the numerator and denominator as normal numbers and perform an iterative algorithm to provide a candidate quotient 328 to input check/output correction floating-point division logic 326.

The floating-point ALU 310 includes the input check/output correction floating-point division logic 326. The “logic” referred to herein is any suitable circuit that can achieve the desired function, and may be a digital circuit, an analog circuit, a mixed analog-digital circuit or any suitable circuit. The input check/output correction floating-point division logic 326 is responsive to the floating-point division fix-up instruction 316 executable by the floating-point ALU 310. The execution of the floating-point division fix-up instruction 316, in this example, causes the input check/output correction floating-point division logic 326 to check the numerator and denominator of floating-point division from the registers 312 to determine whether a special case of floating-point division occurs, and also to provide a corrected floating-point division result based on the determined special case and the candidate quotient 328 calculated by the floating-point adder/subtractor and multiplier 322, 324.

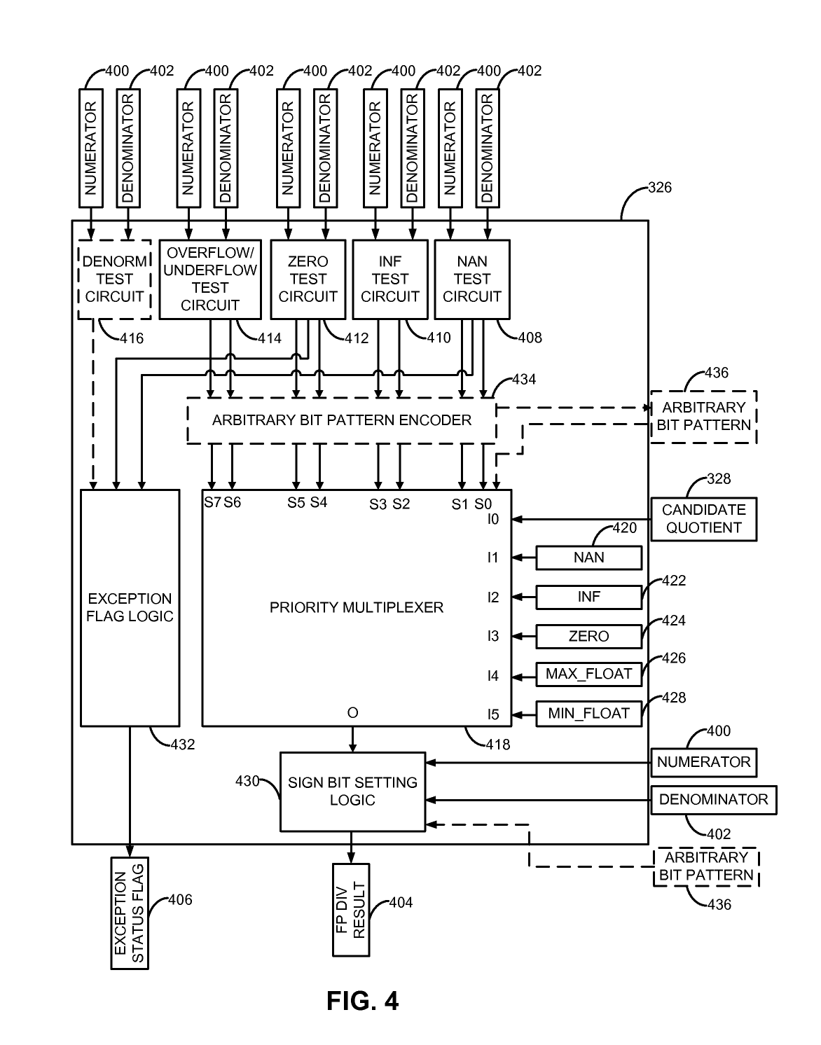

FIG. 4 illustrates one example of the input check/output correction floating-point division logic 326. The input check/output correction floating-point division logic 326 has at least a first input receiving a numerator 400, a second input receiving a denominator 402, and a third input receiving the candidate quotient 328 from the registers 312. The candidate quotient 328, if desired, may be received directly from the floating-point adder/subtractor and multiplier 322, 324. The numerator 400, denominator 402, and candidate quotient 328 are floating-point numbers such as but not limited to single-precision (32-bit) floating-point numbers, double-precision (64-bit) floating-point numbers, single-extended precision (≧43-bit) floating-point numbers, and double-extended precision (≧79-bit) floating-point numbers. In addition, the input check/output correction floating-point division logic 326 has at least a first output providing a floating-point division result 404 and a second output providing an exception status flag 406 to the registers 312, or directly to any logic in the processor 304 if desired.

In this example, the input check/output correction floating-point division logic 326 includes a plurality of special case test circuits 408-414 operative to examine the numerator 400 and denominator 402 to determine whether a special case of floating-point division occurs. The plurality of special case test circuits 408-414 includes a “not-a-number” (NaN) test circuit 408, an infinity (inf) test circuit 410, a zero test circuit 412, and an overflow/underflow test circuit 414. Each one of the special case test circuits 408-414 is operative to check one or more specific special cases of floating-point division defined by IEEE Std. 754. The input check/output correction floating-point division logic 326 may also include a denormalized numbers (denorm) test circuit 416 operative to check whether the numerator 400 or denominator 402 is denorm. In this example, the denorm test circuit 416 is not used for providing the floating-point division result 404, but used for generating the exception status flag 406. Any combination logic that can perform the functions described below may be used as the special case test circuits 408-414 and the denorm test circuit 416. For example, the NaN test circuit 408 examines the exponent and fraction bits of the numerator 400 and denominator 402 to determine whether the numerator 400 is NaN and whether the denominator 402 is NaN. The two outputs of the NaN test circuit 408 indicate whether the numerator 400 or the denominator 402 is NaN, respectively. The same shall be applied to the inf and zero test circuits 410, 412. Table 1 summarizes conditions to determine whether a floating-point number is NaN, inf, zero or denorm.

TABLE 1

| Type | Exponent | Fraction |
|---|---|---|
| NaN | 2^{e}−1 | non zero |
| Inf | 2^{e}−1 | 0 |
| Zero | 0 | 0 |
| Denorm | 0 | non zero |

As to the overflow/underflow test circuit 414, it examines the exponent of the numerator 400 and denominator 402 to determine whether the numerator 400 and denominator 402 are larger or smaller than a given range specified, for example, by IEEE Std. 754. The range depends on the formats of the floating-point number defined in IEEE Std. 754.

The input check/output correction floating-point division logic 326 also includes a priority multiplex 418 operatively connected to the special case test circuits 408-414. The priority multiplex 418 receives the outputs of the special case test circuits 408-414 as its selector inputs S0-S7. The inputs I0-I5 of the priority multiplex 418 include the candidate quotient 328 and special values such as NaN 420, inf 422, zero 424, maximum float constant (max_float) 426, and minimum float constant (min_float) 428. The priority multiplex 418 may be designed, for example, by implementing the following exemplary “If” statement using any suitable combination logic known in the art:

IF numerator=NaN THEN result=NaN;
ELSEIF denominator=NaN THEN result=NaN;
ELSEIF numerator=denominator=zero THEN result=NaN;
ELSEIF numerator=denominator=inf THEN result=NaN;
ELSEIF denominator=zero OR numerator=inf THEN result=inf;
ELSEIF denominator=inf OR numerator=zero THEN result=zero;
ELSEIF overflow THEN result=max_float/inf;
ELSEIF underflow THEN result=min_float/zero;
ELSE result=candidate quotient;
END IF

The “If” statement implies a priority, so the conditions to select the correct input must be checked in order. For example, the priority multiplex 418 first checks the selector input S0 from the NaN test circuit 408 to determine if the numerator 400 is NaN, and if so, the priority multiplex 418 selects the input Il representing NaN 420 as its output without regard to other selector inputs S1-S7. If the numerator 400 is not NaN, the priority multiplex 418 continues to check the selector input S1 from the NaN test circuit 408 to determine if the denominator 402 is NaN, and if so, the priority multiplex 418 selects the input I1 representing NaN 420 as its output. It is noted that, after the special cases of NaN, inf, and zero being checked by the priority multiplexer 418, and if none of the three special cases occurs, the priority multiplexer 418 checks the selector inputs S6 and S7 from the overflow/underflow test circuit 414 to determine if an overflow or underflow special case occurs, and outputs a special value accordingly. For example, if an overflow is determined, the special value may be either a constant—max_float 426 defined in IEEE Std. 754 or inf 422 depending on the rounding mode used in the floating-point division as specified in IEEE Std. 754. Likewise, the special value of the underflow case may be either min_float 428 or zero 424 depending on the rounding mode of the floating-point division.

Although the conditions of special cases of floating-point division are illustrated in a particular order in the exemplary “If” statement, those having ordinary skill in the art will appreciate that the conditions may be checked in different orders by the priority multiplexer 418. In one example, the priority multiplexer 418 may check the statement of “ELSEIF numerator=denominator=inf THEN result=NaN” prior to the statement of “ELSEIF numerator=denominator=zero THEN result=NaN”. In another example, the priority multiplexer 418 may check the statement of “ELSEIF denominator=inf OR numerator=zero THEN result=zero” prior to the statement of “ELSEIF denominator=zero OR numerator=inf THEN result=inf”. In still another example, the priority multiplexer 418 may check the statement of “ELSEIF underflow THEN result=min_float/zero” prior to the statement of “ELSEIF overflow THEN result=max_float/inf”.

In this example, all the conditions of special cases of floating-point division have higher priorities than the condition of selecting the candidate quotient 328. Eventually, if none of the special cases of floating-point division is determined, the priority multiplex 418 selects the input I0 representing the candidate quotient 328 as its output.

The input check/output correction floating-point division logic 326 may further include sign bit setting logic 430 operatively connected to the priority multiplexer 418. As defined in IEEE Std. 754, the sign of a floating-point number is set by a sign bit. Some special values of floating-point division like inf 422 and zero 424 are also signed values, which means the floating-point division result 404 may be +inf, −inf, +zero or −zero depending on the sign bits of the numerator 400 and the denominator 402. The sign bit setting logic 430 sets the sign bit of the floating-point division result 404 based on the sign bits of the received numerator 400 and denominator 402. For example, the sign bit of the floating-point division result 404 is the “exclusive OR” of the sign bits of the numerator 400 and denominator 402. Optionally, the floating-point adder/subtractor and multiplier 322, 324 may ignore the sign bits of the numerator 400 and denominator 402 when numerically calculating the candidate quotient 328, and provide an unsigned candidate quotient 328 to the input check/output correction floating-point division logic 326; and if the candidate quotient 328 is determined by the priority multiplexer 418 as its output, the sign bit of the candidate quotient 328 is then set by the sign bit setting logic 430 based on the sign bits of the numerator 400 and the denominator 402. After setting the sign bit, the input check/output correction floating-point division logic 326 outputs the signed floating-point division result 404 as the first output. As noted above, the floating-point division result 404 may be stored in the registers 312, or sent to any logic in the processor 304 directly if desired.

In addition to the first output representing the floating-point division result 404, the input check/output correction floating-point division logic 326 may also include exception flag logic 432 operative to provide a second output representing an exception status flag 406 in accordance with the requirement of IEEE Std. 754. As described above, the exception status flag 406 invokes default or alternate handling for the signaled exception, such as enabling processing of a trap sequence, which interrupts the normal flow of instruction execution. As shown in FIG. 4, in this example, each one of the NaN test circuit 408 and zero test circuit 412 has an output connected to the exception flag logic 432, which indicates one particular exception. For example, the zero test circuit 412 may send a “division by zero” signal to the exception flag logic 432 once the denominator 402 is determined as zero. The NaN test circuit 408 may send an “invalid operation” signal to the exception flag logic 432 once the numerator 400 and denominator 402 are both zero or inf. Other exceptions defined in IEEE Std. 754 such as but not limited to the “inexact” exception may also be determined and sent to the exception flag logic 432 as exception signals if desired. As to the denorm test circuit 416, although denorm is not an exception required by IEEE Std. 754, optionally, it may be necessary to consider denorm as an additional exception for the processor 304 as known in the art. In this example, the denorm test circuit 416 examines the numerator 400 and denominator 402 to determine whether any one of them is denorm. As shown in Table 1, a floating-point number is denorm if the exponent is zero and the fraction is non-zero.

The exception flag logic 432 then sets the exception status flag 406 according to all the received exception signals and outputs the exception status flag 406 as the second output of the input check/output correction floating-point division logic 326. As noted above, the exception status flag 406 may be stored in the registers 312, or sent to any logic in the processor 304 directly if desired.

Optionally, the input check/output correction floating-point division logic 326 may further include an arbitrary bit pattern (ABP) encoder 434 operatively connected to the special case test circuits 408-414. The ABP encoder 434, in this example, generates an arbitrary bit pattern (ABP) 436 that represents the special cases determined by the special case test circuits 408-414. The ABP 436 is stored in the registers 312. In this example, instead of directly receiving outputs from the special case test circuits 408-414 as described above, the priority multiplexer 418 may receive the ABP 436 from the registers 312 to its selector inputs S0-S7 as control signals. The ABP 436 may also include the information regarding the sign bits of the numerator 400 and denominator 402 and thus, can be used by the sign bit setting logic 430 to set the sign bit of the floating-point division result 404.

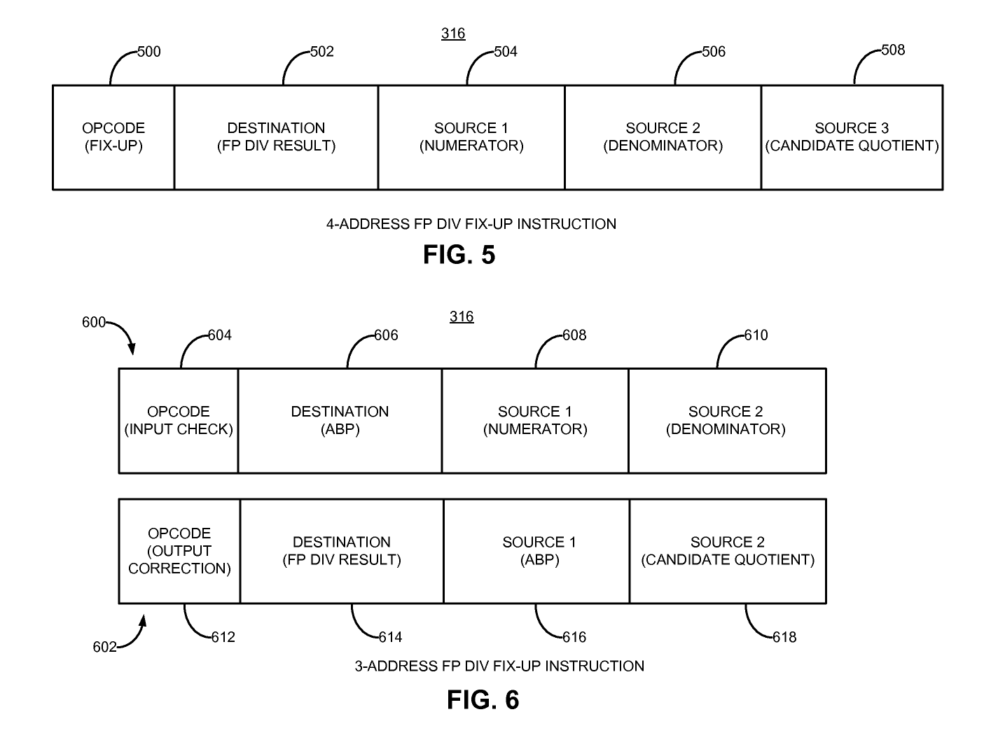

FIGS. 5 and 6 illustrate exemplary instruction formats of the floating-point division fix-up instruction 316. FIG. 5 shows a single floating-point division fix-up instruction 316 that is executed by the processor 304 in one clock cycle. The time of one clock cycle is determined by the clock frequency of the processor 304, and is, for example, from about 0.5 ns to about 10 ns. In this example, the time of one clock cycle is about 1.18 ns for a processor 304 operating at a clock frequency of 850 MHz. It is understood that more than one floating-point division fix-up instructions 316 may be parallel executed in one clock cycle. The floating-point division fix-up instruction 316 may be but is not limited to a 16-bit instruction, a 32-bit instruction or a 64-bit instruction. FIG. 5 is an exemplary instruction format of the single floating-point division fix-up instruction 316 in a four-address ISA. The operation code (opcode) 500, which is a binary encoding specifying the instruction, is for example, “fix-up”. The opcode 500 is used to identify the instruction, and its name is arbitrary. The number of bits of the opcode 500 may vary depending on the different ISAs. The destination 502, source 1 504, source 2 506, and source 3 508 are encoded to specify a register number, memory address, memory offset or any suitable combination thereof that stores the data needed for the instruction 316. In this example, destination 502 points to a destination register of the registers 312 that stores the floating-point division result 404 after the floating-point division fix-up instruction 316 being executed. Source 1 504 and source 2 506 refer to source registers of the registers 312 that hold the numerator 400 and denominator 402, respectively, which are the two inputs of the input check/output correction floating-point division logic 326 as described above. Source 3 points to a source register the registers 312 that holds the candidate quotient 328, which is another input of the input check/output correction floating-point division logic 326. The number of bits of the destination 502, source 1 504, source 2 506, and source 3 508 are determined based on the specific ISA and the number of the registers 312.

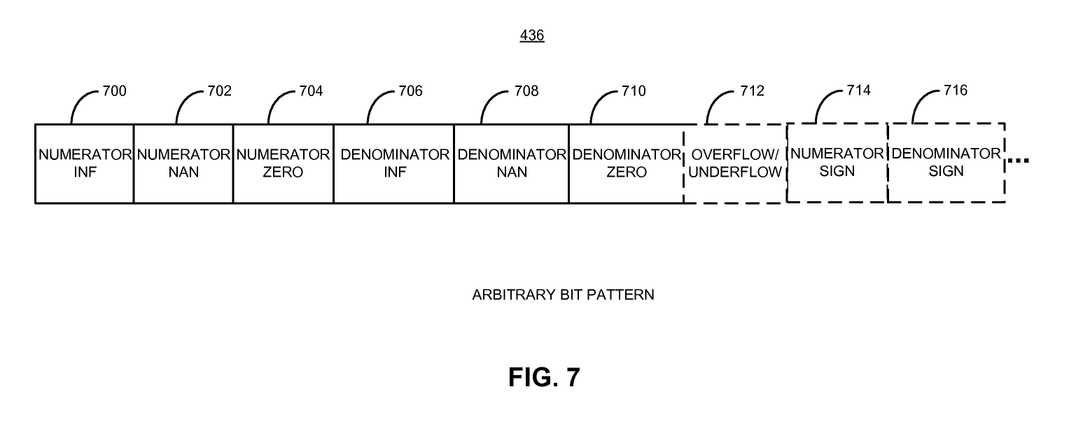

Now referring to FIG. 6, the floating-point division fix-up instruction 316, in this example, includes two three-address instructions for a three-address ISA: an input check instruction 600 and an output correction instruction 602. Each one of the two instructions 600, 602 is executed in one clock cycle, and the entire floating-point division fix-up instruction 316 in this example is executed in two clock cycles. The input check instruction 600 includes an opcode 604 of, for example, “input check”. Different from the instruction format in FIG. 5, the destination 606 of the input check instruction 600 specifies a register that holds ABP 436. FIG. 7 shows one example of ABP 436. ABP 436 may be encoded by the ABP encoder 434 based on the special cases check results from the special case test circuits 408-414. In this example, ABP 436 includes portions indicating whether the numerator is inf 700, NaN 702, and zero 704, and whether the denominator is inf 706, NaN 708, and zero 710. ABP 436 may also include a portion 712 indicating whether an overflow or underflow special case occurs, and portions 714, 716 indicating the sign bits of the numerator 400 and denominator 402, respectively. It is understood that the encoding and format of ABP 436 are arbitrary. ABP 436 may include a number of unused bits depending on the size of ABP 436 (e.g., 32-bit ABP, 64-bit ABP). Now referring back to FIG. 6, source 1 608 and source 2 610 of the input check instruction 600 refer to the source registers of the registers 312 that hold the numerator 400 and denominator 402, respectively. By executing the input check instruction 600, the input check/output correction floating-point division logic 326 checks the numerator 400 and denominator 402 and generates ABP 436 that represents the input check results.

On the other hand, the output correction instruction 602 is identified by an opcode 612 of, for example, “output correction”. The destination 614, source 1 616, and source 2 618 of the output correction instruction 602 specify registers 312 that store the floating-point division result 404, ABP 436, and candidate quotient 328, respectively. Normally, the output correction instruction 602 is executed after the input check instruction 600, and causes the input check/output correction floating-point division logic 326 to output the floating-point division result 404 based on the determined special cases of floating-point division represented by ABP 436 and the candidate quotient 328.

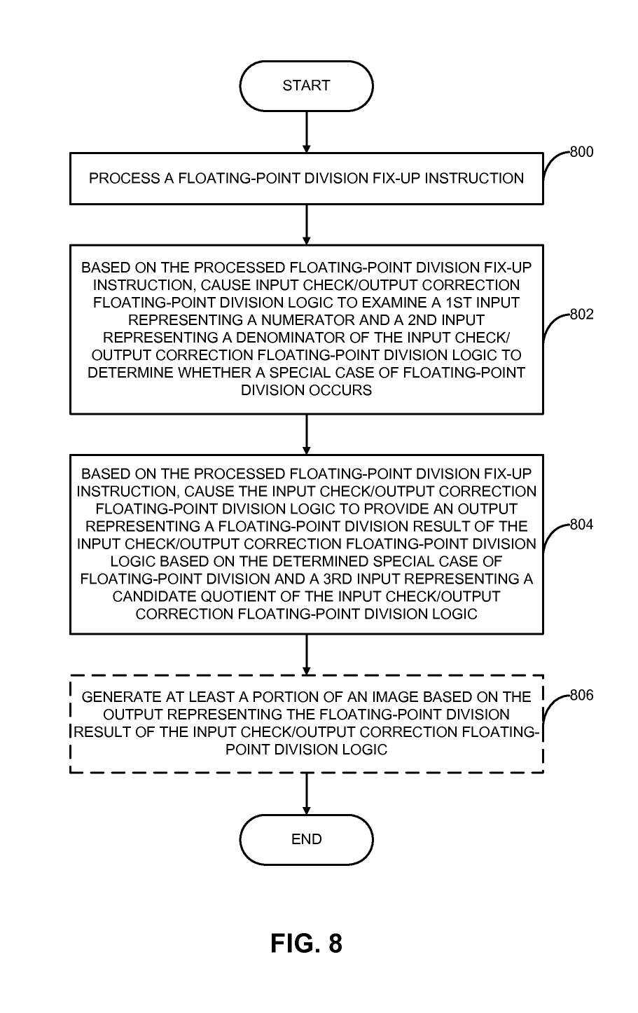

FIG. 8 is a flowchart illustrating one example of a method for performing floating-point division in accordance with one embodiment set forth in the disclosure. It will be described with reference to the above figures. However, any suitable logic or structure may be employed. In operation, the floating-point division fix-up instruction 316 is processed at block 800. For example, the floating-point division fix-up instruction 316 may be loaded from the instruction cache 314, decoded by an instruction decoder, and executed by the processor 304 (i.e., the floating-point ALU 310). At block 802, the execution of the floating-point division fix-up instruction 316 then causes the input check/output correction floating-point division logic 326, specifically, the special case test circuits 408-414 to examine the first input representing the numerator 400 and the second input representing the denominator 402 to determine whether a special case of floating-point division occurs. At block 804, the execution of the floating-point division fix-up instruction 316 also causes the priority multiplexer 418 of the input check/output correction floating-point division logic 326 to provide the output representing the floating-point division result 404 based on the determined special case of floating-point division and the third input representing the candidate quotient 328. As described above, the execution of the floating-point division fix-up instruction 316 may be in one or two clock cycles. Accordingly, blocks 800-804 may be performed in one or two clock cycles.

In one example embodiment in accordance with the disclosure, the floating-point division result 404 may be used for various purposes by the apparatus 300. For example, the apparatus 300 may include a GPU 304 that generates image data 308 of an image displayed on one or more display screens 306. At block 806, the apparatus 300 may generate at least a portion of the image, e.g., one or more pixels or graphic primitives used to generate pixels, based on the output representing the floating-point division result 404 of the input check/output correction floating-point division logic 326. In one example, the floating-point division result 404 is used for computing matrix inverse in 3D graphic modeling and rendering to generate 3D graphic objects for output 308 to the display screens 306, as known in the art. In another example, the floating-point division result 404 is used by an averaging (mean) filter for smoothing image data 308 and eliminating noise, as known in the art.

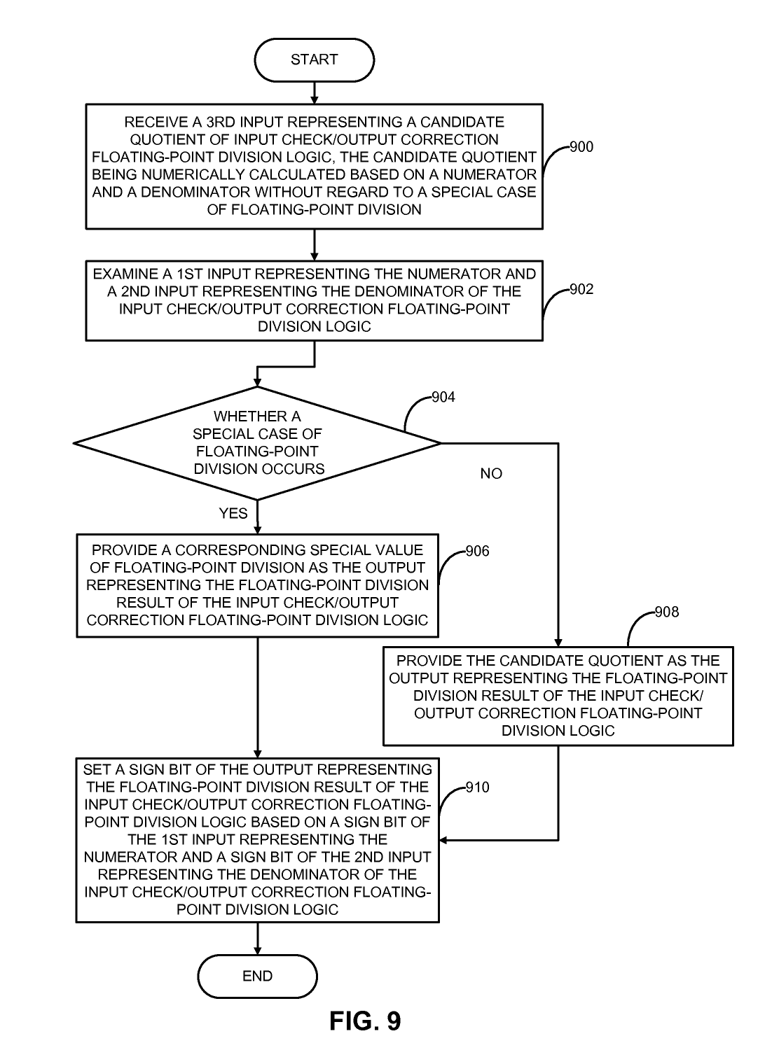

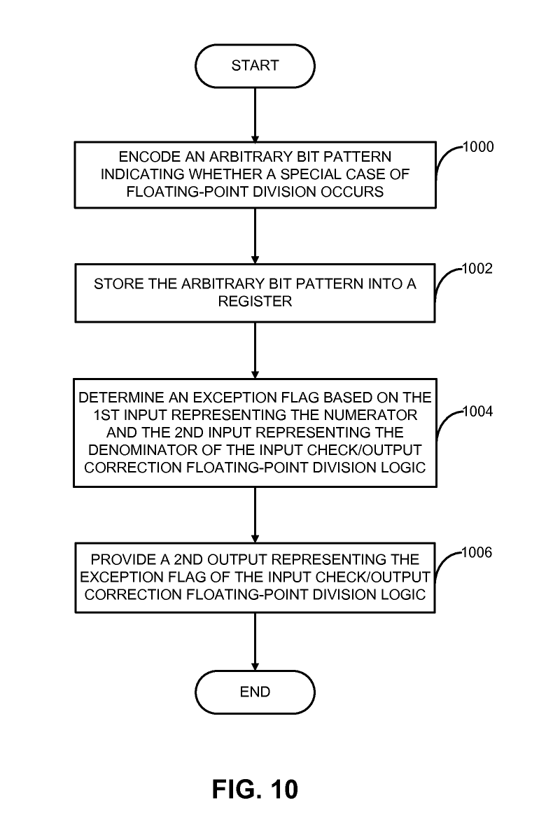

The processor 304 may also be a GPGPU, and the floating-point division result 404 is used for non-graphical computer processing and calculations as a part of the Open Computing Language (OpenCL), which can access the GPU for non-graphical computing. For example, the floating-point division result 404 may be used in numeric algorithms such as but not limited to the computation of eigenvectors and eigenvalues, the interpolation of linear functions or polynomials, and the computation of transcendental functions, rational functions, and partial differential equations, to name a few. The blocks 802 and 804 are further illustrated in FIGS. 9 and 10.

Referring to FIG. 9, in operation, the executed floating-point division fix-up instruction 316 causes the input check/output correction floating-point division logic 326 to receive the third input representing the candidate quotient 328. As described above, the candidate quotient 328 is numerically calculated based on the numerator 400 and the denominator 402 without regard to the special cases of floating-point division. The numerical calculation is performed using iterative algorithms such as but not limited to Newton-Raphson method and Goldschmidt method. Being separate from the execution of the floating-point division fix-up instruction 316, the numerical calculation is performed by the floating-point adder/subtractor 322 and floating-point multiplier 324 in response to the execution of a plurality of instructions such as the floating-point addition/subtraction and floating-point multiplication instructions 318, 320. As the numerical calculation assumes the numerator 400 and denominator 402 are both normal floating-point numbers and does not consider the special cases of floating-point division, no logic or conditional operation is needed.

Proceeding to block 902, the executed floating-point division fix-up instruction 316 causes the special case test circuits 408-414 to examine the numerator 400 and denominator 402. Based on the examination, at block 904, the executed floating-point division fix-up instruction 316 causes the input check/output correction floating-point division logic 326 to determine whether one of the special cases of floating-point division occurs. If a special case of floating-point division occurs, at block 906, the executed floating-point division fix-up instruction 316 further causes the input check/output correction floating-point division logic 326 to provide a corresponding special value of floating-point division as the output representing the floating-point division result 404. The special value may be one of NaN 420, inf 422, zero 424, max_float 426, and min_float 428 based on the special case that has been identified. As the special case conditions have higher priorities as shown in the “If” statement above, if any one of the special cases occurs, the priority multiplexer 418 disregards the candidate quotient 328 and provides the corresponding special value as its output directly.

On the other hand, if none of the special cases of floating-point division occurs, at block 908, the executed floating-point division fix-up instruction 316 causes the input check/output correction floating-point division logic 326 to provide the candidate quotient 328 as the output representing the floating-point division result 404. As the output of the priority multiplexer 418 may be an unsigned value, at block 910, the executed floating-point division fix-up instruction 316 may cause the sign bit setting logic 430 to set the sign bit of the floating-point division result 404 based on the sign bits of the numerator 400 and denominator 402.

Although the processing blocks illustrated in FIG. 9 are illustrated in a particular order, those having ordinary skill in the art will appreciate that the processing can be performed in different orders. For example, block 900 can be performed after block 902 or performed essentially simultaneously. The input check/output correction floating-point division logic 326 may simultaneously receive the candidate quotient 328 and examine the numerator 400 and denominator 402.

Turning to FIG. 10, in this example, the executed floating-point division fix-up instruction 316 may, at block 1000, cause the ABP encoder 434 to encode ABP 436 indicating whether a special case of floating-point division occurs as shown in FIG. 7. ABP 436 includes information regarding the special cases of floating-point division based on the examination of the numerator 400 and denominator 402, and may also include information indicating the sign bits of the numerator 400 and denominator 402, which can be used by the sign bit setting logic at block 910. ABP 436 is then stored into the registers 312 at block 1002. It is noted that, as being described with respect to FIG. 6, the three-address input check instruction 600 may be executed and cause the input check/output correction floating-point division logic 326 to perform the processing blocks 1000 and 1002. The three-address output correction instruction 602 may further be executed and cause the input check/output correction floating-point division logic 326 to provide the floating-point division result 404 based on ABP 436 and the candidate quotient 328 as shown in blocks 904-910 of FIG. 9.

In this example, to comply with the requirement of providing an exception status flag in IEEE Std. 754, the executed floating-point division fix-up instruction 316 may cause the exception flag logic 432 to determine the exception status flag 406 based on the numerator 400 and denominator 402 at block 1004. Specifically, the determination may be made based on at least the output signals from the NaN test circuit 408 and the zero test circuit 412. The determined exception status flag 406 is then provided as the second output of the input check/output correction floating-point division logic 326 at block 1006.

Although the processing blocks illustrated in FIG. 10 are illustrated in a particular order, those having ordinary skill in the art will appreciate that the processing can be performed in different orders. For example, blocks 1000 and 1002 can be performed after blocks 1004 and 1006 or performed essentially simultaneously. The executed floating-point division fix-up instruction 316 may cause the input check/output correction floating-point division logic 326 to handle ABP 436 and the exception status flag 406 essentially simultaneously.

Also, integrated circuit design systems (e.g., work stations) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic and circuits described herein may also be produced as integrated circuits by such systems using the computer readable medium with instructions stored therein. For example, an integrated circuit with the aforedescribed logic and circuits may be created using such integrated circuit fabrication systems. The computer readable medium stores instructions executable by one or more integrated circuit design systems that causes the one or more integrated circuit design systems to design an integrated circuit. The designed integrated circuit includes a floating-point ALU having input check/output correction floating-point division logic as well as other logic or structure as disclosed herein. The input check/output correction floating-point division logic is responsive to a floating-point division fix-up instruction executable by the floating-point ALU that causes the input check/output correction floating-point division logic to examine a first input representing a numerator and a second input representing a denominator of the input check/output correction floating-point division logic to determine whether a special case of floating-point division occurs, and to provide an output representing a floating-point division result of the input check/output correction floating-point division logic based on the determined special case of floating-point division and a third input representing a candidate quotient of the input check/output correction floating-point division logic.

Among other advantages, the method and apparatus for performing floating-point division provides the ability to enable implementation of floating-point division to be shorter and faster while still being IEEE Std. 754 compliant. The numerical portion of the floating-point division is still calculated by iterative algorithms using the existing floating-point adder/subtractor and multiplier with the corresponding instructions, thereby making the method and apparatus cost-efficient. On the other hand, by applying input check/output correction floating-point division logic and a corresponding floating-point division fix-up instruction, the multiple time-consuming conditional and logic instructions (up to 30 instructions) for recognizing and handling special cases of floating-point division can be replaced in order to reduce the execution time. The proposed techniques, therefore, may be suitable for parallel stream processors such as SIMD processors like GPUs and/or GPGPUs used in computer graphics and/or non-graphic processing and computations. Moreover, the method and apparatus for performing floating-point division can be compliant with IEEE Std. 754. Accordingly, the proposed techniques can retain the benefits of lower processor design and manufacturing costs and the benefit of flexibility of iterative algorithm implementation, while with a low instruction count and a fast execution speed. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. An integrated circuit comprising:
a processor comprising:
a floating-point arithmetic logic unit (ALU) comprising input check/output correction floating-point division logic responsive to a floating-point division fix-up instruction executable by the floating-point ALU that causes the input check/output correction floating-point division logic to:
examine a first input representing a numerator and a second input representing a denominator of the input check/output correction floating-point division logic to determine whether a special case of floating-point division occurs; and
provide an output representing a floating-point division result of the input check/output correction floating-point division logic based on the determined special case of floating-point division and a third input representing a candidate quotient of the input check/output correction floating-point division logic.

2. The integrated circuit of claim 1, wherein the input check/output correction floating-point division logic comprises:
a plurality of special case test circuits operative to examine the first input representing the numerator and the second input representing the denominator of the input check/output correction floating-point division logic to determine whether the special case of floating-point division occurs; and
a priority multiplexer operative to provide the output representing the floating-point division result of the input check/output correction floating-point division logic based on the determined special case of floating-point division and the third input representing the candidate quotient of the input check/output correction floating-point division logic; and
wherein the processor further comprises a plurality of registers, operatively connected to the input check/output correction floating-point division logic, operative to store the numerator, the denominator, the candidate quotient, and the floating-point division result.

3. The integrated circuit of claim 1, wherein the floating-point division fix-up instruction is a single instruction that is executed in one clock cycle.

4. The integrated circuit of claim 1, wherein the floating-point division fix-up instruction is comprised of an input check instruction and an output correction instruction; and wherein each one of the input check instruction and output correction instruction is executed in one clock cycle.

5. The integrated circuit of claim 2, wherein the floating-point ALU further comprises at least one floating-point adder/subtractor and at least one floating-point multiplier; and
wherein the at least one floating-point adder/subtractor and floating-point multiplier are responsive to a plurality of instructions executable by the floating-point ALU that causes the at least one floating-point adder/subtractor and floating-point multiplier to numerically calculate the candidate quotient based on the numerator and the denominator without regard to the special case of floating-point division.

6. The integrated circuit of claim 5, wherein the input check/output correction floating-point division logic is further responsive to the floating-point division fix-up instruction executable by the floating-point ALU that causes the input check/output correction floating-point division logic to, if the special case of floating-point division does not occur, provide the candidate quotient as the output representing the floating-point division result of the input check/output correction floating-point division logic.

7. The integrated circuit of claim 2, wherein the input check/output correction floating-point division logic is further responsive to the floating-point division fix-up instruction executable by the floating-point ALU that causes the input check/output correction floating-point division logic to, if the special case of floating-point division occurs, provide a corresponding special value of floating-point division as the output representing the floating-point division result of the input check/output correction floating-point division logic.

8. The integrated circuit of claim 7, wherein the plurality of special case test circuits comprise:
a not-a-number (NaN) test circuit operative to determine whether the numerator or the denominator is NaN;
a zero test circuit operative to determine whether the numerator or the denominator is zero;
an infinity test circuit operative to determine whether the numerator or the denominator is infinity; and
an overflow/underflow test circuit operative to determine whether an overflow or an underflow occurs based on the numerator and the denominator; and
wherein the special value of floating-point division is selected from at least one of NaN, zero, infinity, maximum float constant, and minimum float constant.

9. The integrated circuit of claim 2, wherein the input check/output correction floating-point division logic further comprises sign bit setting logic, operatively connected to the priority multiplexer, operative to set a sign bit of the output representing the floating-point division result based on a sign bit of the first input representing the numerator and a sign bit of the second input representing the denominator of the input check/output correction floating-point division logic.

10. The integrated circuit of claim 2, wherein the output representing the floating-point division result is a first output of the input check/output correction floating-point division logic; and
wherein the input check/output correction floating-point division logic further comprises exception flag logic operative to:
determine an exception status flag based on the first input representing the numerator and the second input representing the denominator of the input check/output correction floating-point division logic; and
provide a second output representing the exception status flag of the input check/output correction floating-point division logic.

11. The integrated circuit of claim 2, wherein the input check/output correction floating-point division logic further comprises an arbitrary bit pattern encoder operative to:
encode an arbitrary bit pattern indicating whether the special case of floating-point division occurs; and
store the arbitrary bit pattern into one of the plurality of registers.

12. The integrated circuit of claim 1, wherein the input check/output correction floating-point division logic is part of a graphic processing unit (GPU).

13. The integrated circuit of claim 1, wherein the processor is operative to generate at least a portion of an image based on the output representing the floating-point division result of the input check/output correction floating-point division logic.

14. A method comprising:
processing a floating-point division fix-up instruction; and
based on the processed floating-point division fix-up instruction, causing input check/output correction floating-point division logic to:
examine a first input representing a numerator and a second input representing a denominator of the input check/output correction floating-point division logic to determine whether a special case of floating-point division occurs; and
provide an output representing a floating-point division result of the input check/output correction floating-point division logic based on the determined special case of floating-point division and a third input representing a candidate quotient of the input check/output correction floating-point division logic.

15. The method of claim 14, wherein causing comprises causing the input check/output correction floating-point division logic to receive the third input representing the candidate quotient of the input check/output correction floating-point division logic, the candidate quotient being numerically calculated based on the numerator and the denominator without regard to the special case of floating-point division.

16. The method of claim 14, wherein the floating-point division fix-up instruction is a single instruction that is executed in one clock cycle.

17. The method of claim 14, wherein the floating-point division fix-up instruction is comprised of an input check instruction and an output correction instruction; and wherein each one of the input check instruction and output correction instruction is executed in one clock cycle.

18. The method of claim 15, wherein causing comprises causing the input check/output correction floating-point division logic to, if the special case of floating-point division does not occur, provide the candidate quotient as the output representing the floating-point division result of the input check/output correction floating-point division logic.

19. The method of claim 14, wherein causing comprises causing the input check/output correction floating-point division logic to, if the special case of floating-point division occurs, provide a corresponding special value of floating-point division as the output representing the floating-point division result of the input check/output correction floating-point division logic.

20. The method of claim 14, wherein causing comprises causing the input check/output correction floating-point division logic to set a sign bit of the output representing the floating-point division result of the input check/output correction floating-point division logic based on a sign bit of the first input representing the numerator and a sign bit of the second input representing the denominator of the input check/output correction floating-point division logic.

21. The method of claim 14, wherein the output representing the floating-point division result is a first output of the input check/output correction floating-point division logic; and
wherein causing comprises causing the input check/output correction floating-point division logic to:
determine an exception status flag based on the first input representing the numerator and the second input representing the denominator of the input check/output correction floating-point division logic; and
provide a second output representing the exception status flag of the input check/output correction floating-point division logic.

22. The method of claim 14, wherein causing comprises causing the input check/output correction floating-point division logic to:
encode an arbitrary bit pattern indicating whether the special case of floating-point division occurs; and
store the arbitrary bit pattern into a register.

23. An apparatus comprising:
a floating-point arithmetic logic unit (ALU) comprising input check/output correction floating-point division logic responsive to a floating-point division fix-up instruction executable by the floating-point ALU that causes the input check/output correction floating-point division logic to:
examine a first input representing a numerator and a second input representing a denominator of the input check/output correction floating-point division logic to determine whether a special case of floating-point division occurs; and
provide an output representing a floating-point division result of the input check/output correction floating-point division logic based on the determined special case of floating-point division and a third input representing a candidate quotient of the input check/output correction floating-point division logic; and
wherein the apparatus is operative to generate at least a portion of the image based on the output representing the floating-point division result of the input check/output correction floating-point division logic.

24. A computer readable medium storing instructions executable by one or more integrated circuit design systems that causes the one or more integrated circuit design systems to design an integrated circuit comprising a processor comprising:
a floating-point arithmetic logic unit (ALU) comprising input check/output correction floating-point division logic responsive to a floating-point division fix-up instruction executable by the floating-point ALU that causes the input check/output correction floating-point division logic to:
examine a first input representing a numerator and a second input representing a denominator of the input check/output correction floating-point division logic to determine whether a special case of floating-point division occurs; and
provide an output representing a floating-point division result of the input check/output correction floating-point division logic based on the determined special case of floating-point division and a third input representing a candidate quotient of the input check/output correction floating-point division logic.
